(19) United States
(12) Patent Application Publication
(10) Pub. No.: US 2020/0056927 A1
(43) Pub. Date: Feb. 20, 2020

(54) Warehouse System Capable of Detecting Load Quantity Variations by Using Gravity Sensors

(71) Applicant: DIGITALENT TECH., LTD., New Taipei City (TW)

(72) Inventor: Chung-Hao Hsu, Taipei City (TW)

(21) Appl. No.: 16/180,011

(22) Filed: Nov. 5, 2018

(30) Foreign Application Priority Data
Aug. 16, 2018 (TW) 107128606

(51) Int. Cl. G01G 7/06; G01G 19/42; G06Q 10/08; G01N 9/02

(52) U.S. Cl. CPC G01G 7/06; G01N 9/02; G06Q 10/087; G01G 19/42

(57) ABSTRACT

A warehouse system includes N carriers, N gravity sensor sets, a scale device, and a computer device. Each carrier is used for disposing at least one load. Each gravity sensor set is disposed below each carrier for detecting a loading weight of each carrier. The scale device is disposed below the N carriers and the N gravity sensor sets for detecting a total weight of the N carriers, the N gravity sensor sets, and all loads. The computer device is coupled to the N gravity sensor sets and the scale device for generating load quantity variations by using the N gravity sensor sets and the scale device.

### BACKGROUND OF THE INVENTION

### 1. Field of the Invention

The present invention illustrates a warehouse system, and more particularly, a warehouse system capable of detecting load quantity variations by using gravity sensors.

### 2. Description of the Prior Art

With rapid development of technologies, various virtual and physical logistic transaction modes are also adopted in our daily life. For example, a retail transaction mode of unmanned stores is implemented according to technologies of intelligent life communications promoted by government. The retail transaction mode of the unmanned stores is an innovative concept. In addition to changing traditional business management method, the unmanned stores are required to introduce more recognition technologies, product information and communications technologies. Therefore, the retail transaction mode of the unmanned stores can accurately analyze preferences of consumers and thus can provide a new and satisfactory shopping experience for the consumers.

As product quality standards become more strict in recent years, several consumer managements, inventory managements, logistic managements, and product inspection procedures require a lot more manpower. In a traditional physical store, an administrator has to manually update the inventory list, such as purchase volume, shipment volume, a manufacturing date of each product, an expiration date of each product in the warehouse at any time. Since a variety of products are provided in the traditional physical stores, different kinds of products are disposed at different positions. In a traditional physical store, many staffs have to constantly move around to check if the inventory list matches various products. When the administrators move around in the store, customers shopping at the aisles are interfered by the movements of the administrators.

In a current unmanned store, a consumer can directly pick up products placed on the shelves. Before the consumer leaves the store, an electronic wallet interface of a smart phone can display a total purchase price and automatically perform a payment process. Since the payment process can be performed automatically, manpower consumption can be greatly reduced. For example, each product placed on a shelf has a radio frequency identification (RFID) barcode indicating its price. Therefore, a sensor of the unmanned store can generate a total purchase price of the consumer. However, since a variety of products can be provided in the unmanned store, the sensor of a shelf cannot detect quantity variation of each kind of products. The sensor can only detect a total purchase price or a variation of a total weight of all products. Therefore, the administrators still need to periodically check the inventory of the shelf, such as the inventory of a crane machine, or inventory of fresh fruits and vegetables in the large frozen warehouse. In other words, in the traditional physical stores and current unmanned stores, their logistic managements cannot be operated under a fully automated mode.

### SUMMARY OF THE INVENTION

In an embodiment of the present invention, a warehouse system is disclosed. The warehouse system comprises N carriers, N gravity sensor sets, a scale device, and a computer device. Each carrier is configured to dispose at least one load. Each gravity sensor set is disposed below each carrier and configured to detect a loading weight of each carrier. The scale device is disposed below the N carriers and the N gravity sensor sets and configured to detect a total weight of the N carriers, the N gravity sensor sets, and all loads. The computer device is coupled to the N gravity sensor sets and the scale device and configured to generate load quantity variations. When load quantities of M carriers of the N carriers are changed, M gravity sensor sets disposed below the M carriers generate M weight change signals. The computer device generates load quantity variations of the M carriers according to the M weight change signals and a variation of the total weight. M and N are two positive integers and N≥M.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a warehouse system according to an embodiment of the present invention.

FIG. 2 illustrates communications of weight change signals when load quantities of carriers are changed in the warehouse system in FIG. 1.

FIG. 3 illustrates a flow chart of an inventory management method performed by the warehouse system in FIG. 1.

### DETAILED DESCRIPTION

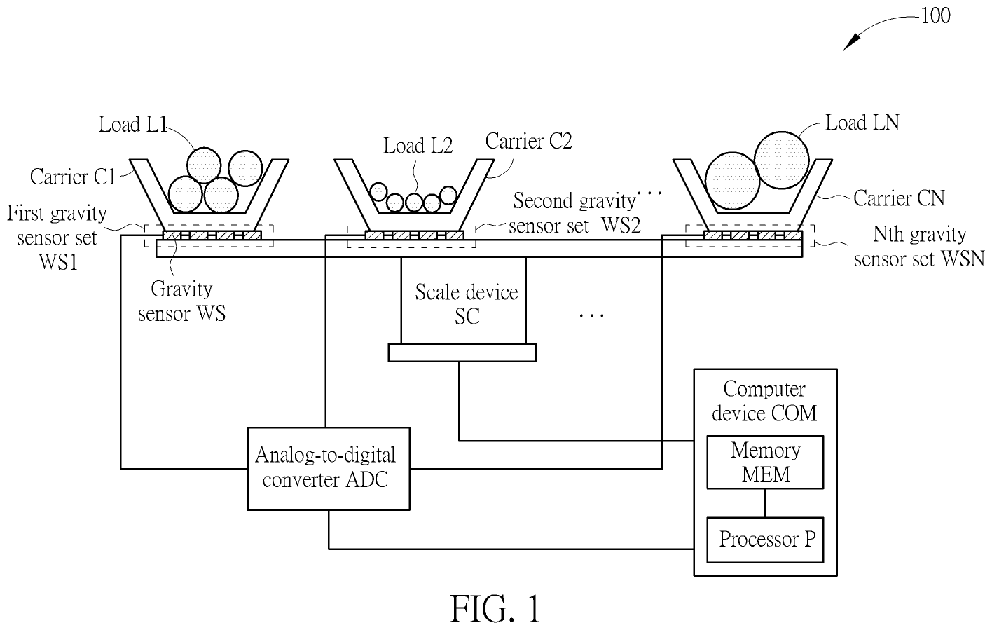

FIG. 1 is a block diagram of a warehouse system 100 according to an embodiment of the present invention. The warehouse system 100 can be applied to any form of unmanned stores or retail stores for greatly reducing human resource consumption and hardware requirement in order to perform inventory managements and logistic managements. The warehouse system 100 includes N carriers C1 to CN, N gravity sensor sets WS1 to WSN, a scale device SC, and a computer device COM. Each carrier of the N carriers C1 to CN is used for disposing (or say, placing) at least one load. For example, four identical loads L1 are placed on the carrier C1. Five identical loads L2 are placed on the carrier C2. Two identical loads LN are placed on the carrier CN. N is a positive integer. Weights of the N carriers C1 to CN can be identical or different. Here, the N carriers C1 to CN are not connected to each other. Therefore, their loading weights are not interfered with each other. In other words, each of the N carriers C1 to CN can be regarded as an individual carrier or container. In the warehouse system 100, the N carriers C1 to CN can be used for disposing N kinds of loads. Weights of the N kinds of loads can be different. Each gravity sensor set of the N gravity sensor sets WS1 to WSN can be disposed below each carrier for detecting a loading weight of the carrier. For example, a first gravity sensor set WS1 can be disposed below the carrier C1 for detecting a loading weight of the carrier C1 (i.e., weight of the carrier C1 is previously known). A second gravity sensor set WS2 can be disposed below the carrier C2 for detecting a loading weight of the carrier C2 (i.e., weight of the carrier C2 is previously known). Similarly, an N^{th} gravity sensor set WSN can be disposed below the carrier CN for detecting a loading weight of the carrier CN (i.e., weight of the carrier CN is previously known). Here, each gravity sensor set can include at least two gravity sensors WS. The at least two gravity sensors WS can be uniformly distributed below a lower surface of each carrier. For example, in FIG. 1, the first gravity sensor set WS1 can include four gravity sensors WS. The four gravity sensors WS can be uniformly distributed below a lower surface of the carrier C1. Specifically, the four gravity sensors WS can be formed by a Wheatstone bridge for detecting the loading weight of the carrier C1 having at least one load. In a circuit structure of the Wheatstone bridge of the first gravity sensor set WS1, two pair-wised sensors can be connected in series. Two serially connected sensors can be connected with other two serially connected sensors in parallel in order to form the Wheatstone bridge. When at least one gravity sensor WS of the first gravity sensor set WS1 changes its coupling resistance due to gravity variation, the Wheatstone bridge can generate a current since matching resistance ratios of the four gravity sensors WS are imbalanced. For simplicity, a current generated by each gravity sensor set is called as “a weight change signal” hereafter. Moreover, each gravity sensor set of the warehouse system 100 is not limited to using four gravity sensors WS. Any reasonable number of gravity sensors WS used for the warehouse system 100 falls into the scope of the present invention.

The scale device SC is disposed below the N carriers C1 to CN and the N gravity sensor sets WS1 to WSN for detecting a total weight of the N carriers C1 to CN, the N gravity sensor sets WS1 to WSN, and all loads (i.e., four identical loads L1, five identical loads L2, . . . , two identical loads LN). The computer device COM is coupled to the N gravity sensor sets WS1 to WSN and the scale device SC for generating load quantity variations. The computer device COM can include a memory MEM for saving a weight of single load disposed on each carrier of the N carriers C1 to CN. For example, the memory MEM can include a lookup table. The lookup table can include information such as “a weight of a single load L1 is 100 grams”, “a weight of a single load L2 is 50 grams”, . . . , “a weight of a single load LN is 200 grams”. The computer device COM can further include a processor P coupled to the memory MEM for generating the load quantity variations when load quantities of some carriers are changed. Further, the warehouse system 100 can further include an analog-to-digital converter ADC coupled to the computer device COM for digitize all weight change signals generated from the N gravity sensor sets WS1 to WSN. Particularly, any reasonable hardware modification of the warehouse system 100 falls into the scope of the present invention. For example, the analog-to-digital converter ADC can be integrated with the computer device COM. Therefore, the N gravity sensor sets WS1 to WSN and the scale device SC can be directly coupled to the computer device COM without introducing an external analog-to-digital converter. In another hardware design, the scale device SC can include its own analog-to-digital converter. Thus, the scale device SC can be directly coupled to the computer device COM. However, the N gravity sensor sets WS1 to WSN are coupled to the computer device COM through the analog-to-digital converter ADC. Further, in the warehouse system 100, the computer device COM can be a gateway or a cloud server. The computer device COM can record the variation of the total weight generated by the scale device SC and all weight change signals outputted by the N gravity sensor sets WS1 to WSN during a predetermined time interval (i.e., for example, during one daytime or one week) in order to analyze logistic trends of the loads L1 to LN.

In the warehouse system 100, detection accuracy of the scale device SC is greater than detection accuracy of each gravity sensor set of the N gravity sensor sets WS1 to WSN. Further, a gravity detection range of the scale device SC is greater than a gravity detection range of the gravity sensor set of the N gravity sensor sets WS1 to WSN. Therefore, the scale device SC can be used for carrying all gravity sensor sets WS1 to WSN, all carriers C1 to CN, and all loads L1 to LN, and detecting the variation of the total weight at any time. An inventory management method performed by the warehouse system 100 is illustrated below.

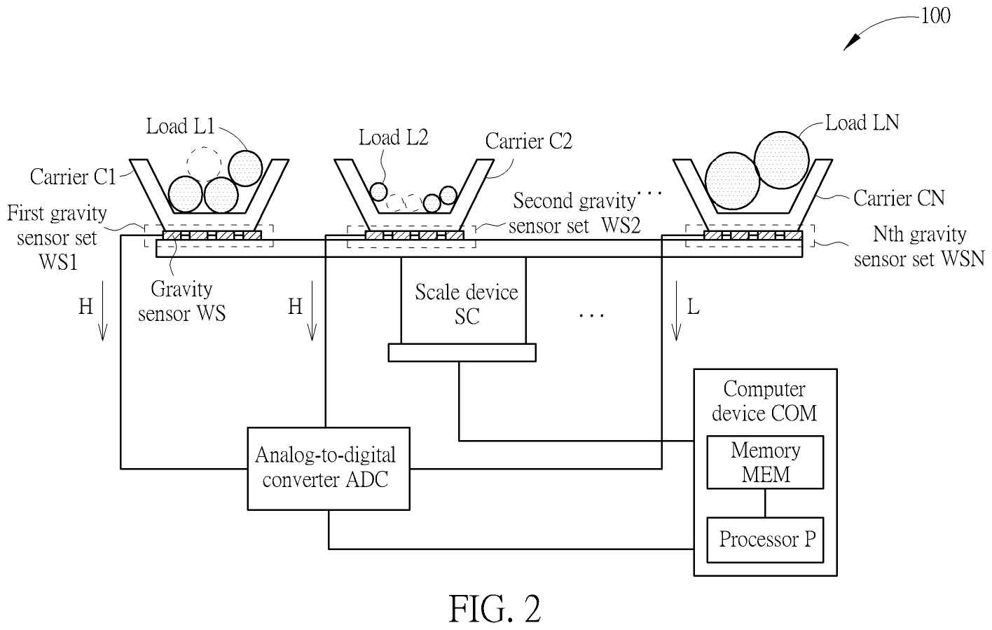

FIG. 2 illustrates communications of weight change signals when load quantities of carriers are changed in the warehouse system 100. As previously mentioned, the warehouse system 100 can be regarded as an automatic inventory management system capable of detecting quantity variation of at least one kind of loads. For simplicity, in the warehouse system 100, a quantity variation of the loads L1 placed on the carrier C1 and a quantity variation of the loads L2 placed on the carrier C2 are illustrated below. The computer device COM of the warehouse system 100 can include the memory MEM for saving the weight of single load disposed on each carrier of the N carriers C1 to CN. For example, the weight of the single load L1 is 100 grams. The weight of the single load L2 is 50 grams. Further, when a variation of the loading weight of the carrier C1 detected by the first gravity sensor set WS1 is greater than or equal to a threshold value (i.e., greater than or equal to the weight of the single load L1), the Wheatstone bridge of the first gravity sensor set WS1 can generate the current since matching resistance ratios of all gravity sensors of the first gravity sensor set WS1 are imbalanced. Therefore, the first gravity sensor set WS1 can output a first voltage level signal H. The first voltage level signal H can be regarded as a weight change signal at the first voltage level. Similarly, when a variation of the loading weight of the carrier C2 detected by the second gravity sensor set WS2 is greater than or equal to a threshold value (i.e., greater than or equal to the weight of the single load L2), the Wheatstone bridge of the second gravity sensor set WS2 can generate the current since matching resistance ratios of all gravity sensors of the second gravity sensor set WS2 are imbalanced. Therefore, the second gravity sensor set WS2 can output the first voltage level signal H. When a variation of the loading weight of the carrier CN detected by the N^{th} gravity sensor set WSN is smaller than a threshold value (i.e., smaller than the weight of the single load LN), the Wheatstone bridge of the N^{th} gravity sensor set WSN can output a second voltage level signal L since matching resistance ratios of all gravity sensors of the N^{th} gravity sensor set WSN are balanced. The second voltage level signal L can be regarded as a weight change signal at the second voltage level. Here, the first voltage level signal H can be a high voltage signal. The second voltage level signal L can be a low voltage signal. In FIG. 2, one of the four loads L1 placed on the carrier C1 is taken away. Therefore, the loading weight of the carrier C1 is changed from 400 grams to 300 grams. In other words, since the variation of the loading weight of the carrier C1 is greater than or equal to 100 grams, the first gravity sensor set WS1 can output the first voltage level signal H. Then, two of the five loads L2 placed on the carrier C2 are taken away. Therefore, the loading weight of the carrier C2 is changed from 250 grams to 150 grams. In other words, since the variation of the loading weight of the carrier C2 is greater than or equal to 50 grams, the second gravity sensor set WS2 can output the first voltage level signal H. However, two loads LN placed on the carrier CN are not taken away. Therefore, the loading weight of the carrier CN maintains 400 grams. In other words, since the variation of the loading weight of the carrier CN is zero, the N^{th} gravity sensor set WSN can output the second voltage level signal L.

As previously mentioned, the scale device SC can be used for carrying the carriers C1 to CN and the N gravity sensor sets WS1 to WSN in order to detect the total weight of the N carriers C1 to CN, the N gravity sensor sets WS1 to WSN, and all loads L1 to LN. The scale device SC can detect the variation of the total weight at any time. Therefore, after one of the four loads L1 placed on the carrier C1 is taken away and then two of the five loads L2 placed on the carrier C2 are taken away, the total weight detected by the scale device SC is changed from W grams to W−100 grams, and then changed from W−100 grams to W−200 grams. W is denoted as an initial weight. Therefore, for the computer device COM, when the total weight detected by the scale device SC is changed from the W grams to W−100 grams, the computer device COM can determine that quantity of removed load L1 of the carrier C1 is equal to 100/100=1 according to the first voltage level signal H generated by the first gravity sensor set WS1 disposed below the carrier C1. Then, when the total weight detected by the scale device SC is changed from the W−100 grams to W−200 grams, the computer device COM can determine that quantity of removed load L2 of the carrier C2 is equal to 100/50=2 according to the first voltage level signal H generated by the second gravity sensor set WS2 disposed below the carrier C2. Further, the computer device COM can determine that quantity of removed load LN of the carrier CN is equal to zero according to the second voltage level signal L generated by the N^{th} gravity sensor set WSN disposed below the carrier CN. Generally, when load quantities of M carriers are changed, loading weights of the M carriers are also changed. When variations of the loading weights of the M carriers are greater than or equal to a threshold value, each of the M weight change signals generated by the M gravity sensor sets disposed below the M carriers of the N carriers includes the first voltage level signal H. The computer device COM can generate load quantity variations of the M carriers according to the M weight change signals and a variation of the total weight. M and N are two positive integers and N≥M. Further, when load quantities of N−M carriers of the N carriers C1 to CN are invariant, loading weights of the N−M carriers maintain constants. Therefore, each of N−M weight change signals generated by N−M gravity sensor sets disposed below the N−M carriers of the N carriers includes the second voltage level signal L.

The aforementioned embodiment illustrates that one of the four loads L1 placed on the carrier C1 is taken away first. Then, two of the five loads L2 placed on the carrier C2 are taken away. Therefore, the total weight detected by the scale device SC is changed from the W grams to W−100 grams, and then changed from the W−100 grams to W−200 grams. However, the warehouse system 100 is not limited to a user gradually taking away different kinds of loads. The warehouse system 100 can also support the user to take away different kinds of loads at the same time. For example, when the user takes away one load L1 placed on the carrier C1 and two loads L2 placed on the carrier C2 at the same time, the first gravity sensor set WS1 and the second gravity sensor set WS2 simultaneously output two first voltage level signals H. Then, the total weight detected by the scale device SC is changed from the W grams to W−200 grams. The memory MEM includes information such as “the weight of the single load L1 is 100 grams”, and “the weight of the single load L2 is 50 grams”. Therefore, the computer device COM can generate a removed load quantity α of the carrier C1 and a removed load quantity β of the carrier C2 by using a linear equation as 100α+50β=200 for α≥1 and β≥1 according to a variation of the total weight (i.e., 200 grams) and the two first voltage level signals H outputted from the first gravity sensor set WS1 and the second gravity sensor set WS2. Here, unique solutions of the equation 100α+50β=200 for α≥1 and β≥1 can be derived as α=1 and β=2. Therefore, even if the user takes away at least one load L1 placed on the carrier C1 and at least one load L2 placed on the carrier C2 at the same time, the warehouse system 100 can detect load quantity variations of the carrier C1 and the carrier C2. In practice, since weights of different kinds of loads are different, the warehouse system 100 can accurately detect variations of load quantities (i.e., all kinds of loads) when the user gradually or simultaneously takes away any kinds of loads. Therefore, the warehouse system 100 can perform the inventory management automatically.

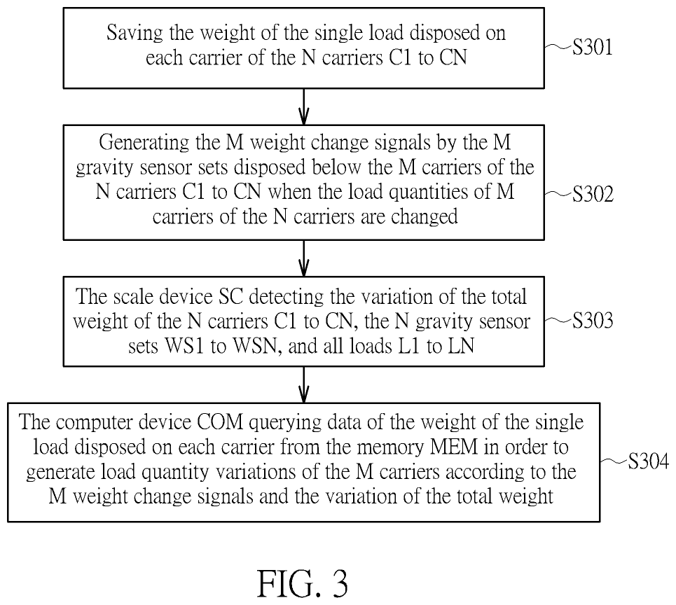

FIG. 3 illustrates a flow chart of an inventory management method performed by the warehouse system 100. The inventory management method performed by the warehouse system 100 includes step S301 to step S304. Any reasonable technology modification of step S301 to step S304 falls into the scope of the present invention. Step S301 to step S304 are illustrated below.
step S301: saving the weight of the single load disposed on each carrier of the N carriers C1 to CN;
step S302: generating the M weight change signals by the M gravity sensor sets disposed below the M carriers of the N carriers C1 to CN when the load quantities of M carriers of the N carriers are changed;
step S303: the scale device SC detecting the variation of the total weight of the N carriers C1 to CN, the N gravity sensor sets WS1 to WSN, and all loads L1 to LN;
step S304: the computer device COM querying data of the weight of the single load disposed on each carrier from the memory MEM in order to generate load quantity variations of the M carriers according to the M weight change signals and the variation of the total weight.

Details of step S301 to step S304 are previously illustrated. Thus, they are omitted here. By using the inventory management method performed by the warehouse system 100 according to step S301 to step S304, the computer device COM can record the variation of the total weight generated by the scale device SC and all weight change signals during the predetermined time interval in order to analyze logistic trends. For example, quantity of a certain kind of loads (i.e., such as the loads LN) is not changed within one week. It implies that no payment process is introduced to the loads LN (or say, a certain kind of products). Therefore, favorability of the loads LN is decreased for the customers. For example, quantity of a certain kind of loads (i.e., such as the loads L1) is varied frequently within one week. It implies that the loads L1 is traded frequently and should be popular for the customers. Thus, the administrator of the warehouse system 100 can re-allocate all kinds of loads placed on the carriers for optimizing business benefit after a logistic analysis and a payment history are generated by the computer device COM.

To sum up, the present invention discloses a warehouse system. The warehouse system is capable of detecting load quantity variations of all carriers. Therefore, manpower consumption can be minimized by using the warehouse system. Moreover, since the warehouse system of the present invention is capable of detecting the load quantity variations of all carriers, the warehouse system can be applied to smart unmanned stores currently developed in a logistics market. The warehouse system can be applied to front-end operations of a logistic management system. Moreover, the warehouse system only uses one scale device with high detection accuracy and several gravity sensors for detecting the load quantity variations, thereby leading to low hardware complexity and cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A warehouse system comprising:
N carriers, each carrier configured to dispose at least one load;
N gravity sensor sets, each gravity sensor set disposed below the each carrier and configured to detect a loading weight of the each carrier;
a scale device disposed below the N carriers and the N gravity sensor sets and configured to detect a total weight of the N carriers, the N gravity sensor sets, and all loads; and
a computer device coupled to the N gravity sensor sets and the scale device and configured to generate load quantity variations;
wherein when load quantities of M carriers of the N carriers are changed, M gravity sensor sets disposed below the M carriers generate M weight change signals, the computer device generates load quantity variations of the M carriers according to the M weight change signals and a variation of the total weight, M and N are two positive integers and N≥M.

2. The warehouse system of claim 1, wherein the each gravity sensor set comprises at least two gravity sensors, and the at least two gravity sensors are uniformly distributed below a lower surface of the each carrier.

3. The warehouse system of claim 1, wherein the computer device comprises:
a memory configured to save a weight of single load disposed on the each carrier; and
a processor coupled to the memory and configured to generate the load quantity variations of the M carriers according to the M weight change signals when the load quantities of the M carriers are changed.

4. The warehouse system of claim 1, wherein when the load quantities of the M carriers are changed, loading weights of the M carriers are changed, and when variations of the loading weights of the M carriers are greater than or equal to a threshold value, each of the M weight change signals generated by the M gravity sensor sets disposed below the M carriers of the N carriers comprises a first voltage level signal.

5. The warehouse system of claim 4, wherein when load quantities of N−M carriers of the N carriers are invariant, loading weights of the N−M carriers maintain constants, each of N−M weight change signals generated by N−M gravity sensor sets disposed below the N−M carriers of the N carriers comprises a second voltage level signal, and the first voltage level signal and the second voltage level signal are opposite.

6. The warehouse system of claim 4, wherein the N carriers are configured to dispose N kinds of loads, and weights of the N kinds of loads are different.

7. The warehouse system of claim 1, wherein the each gravity sensor is formed by a Wheatstone bridge configured to detect a loading weight of a corresponding carrier having at least one load.

8. The warehouse system of claim 1, further comprising:
an analog-to-digital converter coupled to the computer device and configured to digitize the M weight change signals and the variation of the total weight.

9. The warehouse system of claim 1, wherein the computer device is a gateway or a cloud server, and the computer device records the variation of the total weight generated by the scale device and all weight change signals outputted by the N gravity sensor sets during a predetermined time interval in order to analyze logistic trends.

10. The warehouse system of claim 1, wherein detection accuracy of the scale device is greater than detection accuracy of the each gravity sensor set of the N gravity sensor sets, and a gravity detection range of the scale device is greater than a gravity detection range of the each gravity sensor set of the N gravity sensor sets.
